(19) United States
(12) Patent Application Publication
(10) Pub. No.: US 2024/0295520 A1
(43) Pub. Date: Sep. 5, 2024

(54) PALLADIUM-HYDROGEN PH ELECTRODE

(71) Applicants: Dominic Francis GERVASIO, Tucson, AZ (US); James MAKEL, Tucson, AZ (US); Inho SONG, Tucson, AZ (US); ARIZONA BOARD OF REGENTS ON BEHALF OF THE UNIVERSITY OF ARIZONA, Tucson, AZ (US); GENERAL SENSING LLC, University Heights, OH (US)

(72) Inventors: Dominic Francis Gervasio, Tucson, AZ (US); James Makel, Tucson, AZ (US); Inho Song, University Heights, OH (US)

(21) Appl. No.: 18/573,377

(22) PCT Filed: Jun. 21, 2022
(86) PCT No.: PCT/US2022/034397

§ 371 Date: Dec. 21, 2023

Related U.S. Application Data
(60) Provisional application No. 63/213,183, filed on Jun. 21, 2021.

(51) Int. Cl. G01N 27/30; G01N 27/31; G01N 27/416

(52) U.S. Cl. CPC G01N 27/302; G01N 27/31; G01N 27/4167

(57) ABSTRACT

A palladium reversible hydrogen electrode (RHE) article is provided for measuring pH, wherein the palladium in the RHE is dynamically loaded with hydrogen atoms to reversibly form Pd-H species. A pH measurement device is provided that includes the RHE, which in some embodiments serves as a cathode, and a method is provided for measuring pH using the device. The RHE article may be miniaturized on a chip or wafer, and may be used to detect ions in water (e.g. lead ions in water running through e.g., corroding pipes).

### CROSS-REFERENCE TO RELATED APPLICATIONS

This application claims the benefit of Provisional Appl. No. 63/213,183, filed Jun. 21, 2021. The content of the aforesaid application is relied upon and is incorporated by reference herein in its entirety.

### FIELD OF THE INVENTION

The field of the invention relates generally to pH measurement devices.

### BACKGROUND

pH sensors measure the acidity or alkalinity of a fluid. They can measure pH in a variety of ways, one of which is through use of an electrode. The electrode is placed within the fluid, and the properties of the electrode will cause a voltage to occur based on the pH levels in the fluid. The most common type of electrode used in pH sensors is the glass electrode, which uses a membrane of made of glass that is sensitive to hydrogen ions (which are responsible for change in pH). One downside of glass electrodes, however, is that they tend to be fragile, particularly when miniaturized.

There is a need for simple and robust pH sensors that are suitable for miniaturization.

### SUMMARY

The inventors surprisingly developed a simple palladium-based reversible hydrogen electrode useful for measuring pH and enabling miniaturization, taking advantage of the ability of palladium metal to absorb hydrogen atoms.

In one aspect, the invention provides a palladium reversible hydrogen electrode (RHE) article. In some embodiments, the palladium is palladium metal; in some other embodiments, the palladium is a palladium alloy. The palladium in the RHE may be dynamically loaded with hydrogen atoms to reversibly form Pd-H species.

In another aspect according to the invention, a pH measurement device is provided that includes a cathode and an anode; where the RHE article serves as the cathode.

In a further aspect according to the invention, a method is provided for measuring pH with any of the embodiments of a pH measurement device according to the invention.

A form of the Nernst equation is provided for calculating the pH of a solution pH from a measurement with the RHE article (see Equation V).

Another aspect of the invention pertains to a method for making an RHE article according to the invention, including electrodynamically loading palladium with hydrogen atoms. In some embodiments, the electrodynamically loading step comprises galvanostatic loading.

### BRIEF DESCRIPTION OF THE FIGURES

FIGS. 1A and 1B show exemplary embodiments of a reversible hydrogen electrode of the invention. In particular, FIG. 1A shows a palladium film, and FIG. 1B shows a palladium wire.

FIGS. 2A and 2B show exemplary embodiments of a reversible hydrogen electrode of the invention including a membrane coating layer. In particular, FIG. 2A shows a membrane coated palladium film, and FIG. 1B shows a membrane coated palladium wire.

FIG. 3 is a flow diagram showing a dip coating process to form a membrane coated palladium wire of the invention.

FIG. 4 is a graph showing potential of a hydrogen-loaded palladium electrode of an exemplary embodiment according to the invention as a function of pH.

FIG. 5 illustrates a use of the graph of FIG. 4 as a calibration curve for measuring the pH of a solution, using a hydrogen-loaded pH electrode according to the invention.

FIG. 6 is a schematic diagram of an exemplary embodiment of a pH measuring device according to the invention, illustrating a configuration of the pH measuring device for measuring the pH of a solution.

FIG. 7 is a schematic diagram of an exemplary embodiment of a pH measuring device according to the invention, illustrating a layout of the pH measurement device suitable for a chip format.

It is to be understood that the following detailed description is exemplary and explanatory only and is not restrictive of the invention, as claimed.

### DETAILED DESCRIPTION

### Definitions

For the purposes of promoting an understanding of the principles of the invention, reference will now be made to certain embodiments and specific language will be used to describe the same. It will nevertheless be understood that no limitation of the scope of the invention is thereby intended, and alterations and modifications in the illustrated invention, and further applications of the principles of the invention as illustrated therein are herein contemplated as would normally occur to one skilled in the art to which the invention relates.

Unless defined otherwise, all technical and scientific terms used herein have the same meaning as commonly understood by one of ordinary skill in the art to which this invention pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” or “an” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more embodiments uses the term “comprising,” those skilled in the art would understand that, in some specific instances, the embodiment or embodiments can be alternatively described using the language “consisting essentially of” and/or “consisting of.”

As used herein, the term “about” refers to a +10% variation from the nominal value. It is to be understood that such a variation is always included in any given value provided herein, whether or not specifically referred to.

As used herein, the term “palladium-hydrogen pH-electrode” or “Pd-H electrode” refers to a hydrogen pH electrode comprising a palladium component dynamically loaded with hydrogen atoms, wherein the palladium component comprises palladium (Pd) metal or a palladium alloy. Palladium metal may be substituted for a palladium alloy (and vice versa) in the embodiments of the invention. For example, where the invention calls for a palladium wire in a particular embodiment, the invention contemplates that a palladium alloy wire can be used as a substitute.

The term “Pd-H electrode” is used interchangeably herein with the term “Reversible Hydrogen Electrode (RHE)” to refer to a Reversible Hydrogen Electrode (RHE) article according to the invention.

### Reversible Hydrogen Electrode

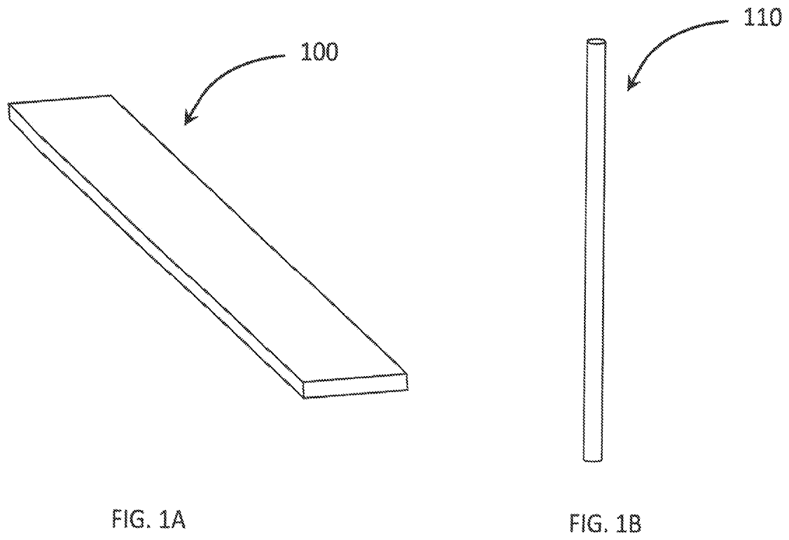

One aspect of the invention pertains to a reversible hydrogen electrode (“RHE”) article, wherein said article comprises palladium, wherein the palladium is palladium metal or a palladium alloy, and wherein the palladium is dynamically loaded with hydrogen atoms to reversibly form Pd-H species. Without wishing to be limited by theory, the potential of a palladium metal electrode dynamically loaded with hydrogen atoms (“Pd-H electrode”) is effectively used as a pH-indicating reversible hydrogen electrode. FIG. 1A shows an exemplary embodiment of a reversible hydrogen electrode 100 wherein the palladium is in the form of a palladium film, and FIG. 1B shows an embodiment of an RHE 110 wherein the palladium is in the form of a palladium wire.

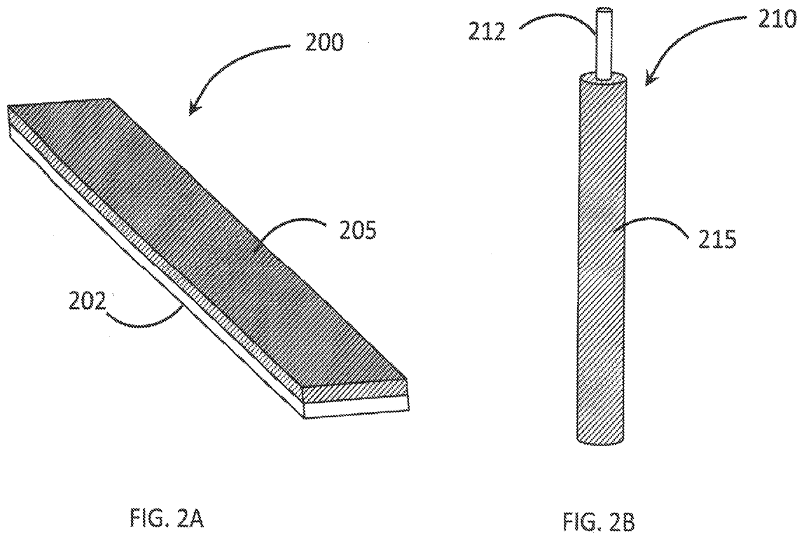

In some embodiments, an RHE of the invention further comprises a membrane disposed on the palladium. FIG. 2A shows an embodiment of an RHE 200 wherein a membrane 205 is disposed on a palladium film 202, and FIG. 2B shows an embodiment of an RHE 210 wherein a membrane 215 is disposed on a palladium wire 212. In some embodiments, the membrane disposed on the palladium of the RHE is a sulfonated polytetrafluoroethylene.

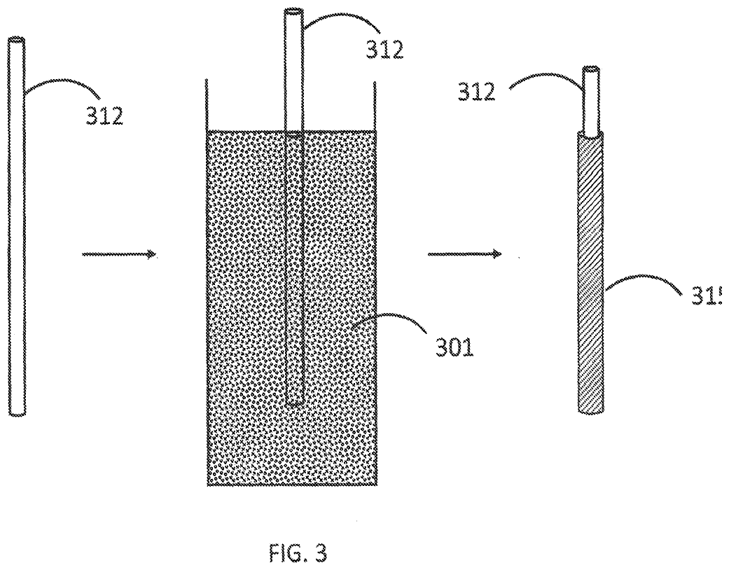

An exemplary embodiment of a dip-coating process for applying a membrane coating for an RHE is illustrated in FIG. 3. Palladium wire 312 is dipped into a coating solution 301 of e.g., sulfonated polytetrafluoroethylene (in a suitable solvent such as [symbol] ), and then dried to provide a palladium wire 312 with a membrane coating 315. The process of dipping the palladium wire into coating solution 301 and then drying the membrane coating can be repeated several times to provide a thicker membrane coating on the palladium wire 312. An analogous dip-coating process can be followed to produce a membrane-coated palladium film.

In some embodiments, the RHE of the invention may be disposed on a substrate. Suitable substrates may include, for example, a plastic (e.g., an oriented polyethylene terephthalate such as MYLAR), glass (e.g., fused silica), alumina, or silicon (e.g., an undoped silicon).

In some embodiments, the invention encompasses a reversible hydrogen electrode (RHE) comprising a palladium metal electrode dynamically loaded with hydrogen atoms.

The potential of the Pd metal electrode dynamically loaded with hydrogen atoms (Pd-H) according to the invention is measured versus a pH insensitive silver/silver chloride reference electrode (SSE). When placed in a solution, the potential, “E”, of an electrode is dictated by the Nernst equation:

$$E = {E}^{o} - 2.3 \; 03 ( RT / nF ) {log}_{10} K \qquad ( Equation I )$$

wherein: E° is the standard reduction potential versus the normal hydrogen electrode (NHE) with a potential defined as 0 volts (V);
n is the number of electrons transferred;
F is the Faraday constant (96,500 C/mol);
R is the gas constant (8.314 J/[° K Mole]);
T is the Kelvin temperature;
K is the equilibrium constant, which is the ratio of the concentration of the products over concentration of the reactants in a chemical equation, i.e., [products]/[reactants].
   At standard temperature (T=298° K), the value of the 2.303*RTF term equals 0.0592 V, so the Nernst equation becomes:

$$E = {E}^{o} - ( 0.0 \; 592 V / n ) {log}_{10} K \qquad Equation ( II )$$

For the reaction H⁺+e→½ H₂ and noting that, n=1, [H₂]=1 and E (SSE)=+0.2 V vs NHE, the Nernst equation becomes:

$${E}^{RHE} = {E}^{NHE} - ( 0.0 \; 592 V ) log [ {H}^{+} ] \qquad Equation ( III )$$

When the palladium metal electrode is made a cathode to dynamically load it with hydrogen atoms, and the potential of this Pd-H electrode is measured versus SSE, and this potential difference of Pd-H minus SSE is proportional to the pH of a solution, the equation becomes:

$${E}^{RHE} = {E}^{NHE} - ( 0.0 \; 592 V ) log [ {H}^{+} ] \qquad ( Equation IV )$$

and since E (SSE)=+0.2 V vs NHE, the Nernst equation is:

$${E}^{RHE} = + 0.2 V - ( 0.0592 V ) log [ {H}^{+} ] \qquad ( Equation V )$$

The above form of the Nernst equation (i.e., equation V) gives the response of the Pd-H electrode versus SSE when the Pd-H electrode and SSE electrodes are in the same solution. Experimental description of Pd-H electrode

In general, a palladium film or wire that is used as a cathode in an aqueous electrolyte solution is galvanostatically loaded with hydrogen atoms, using a current density of 500 uA/cm² for one minute. The potential is then allowed to equilibrate for one minute, and then the open circuit voltage is measured. The measured open circuit voltage (“OCV”) is the potential of the Pd-H electrode minus the potential of the SSE, so the palladium cathode potential is the OCV. Pd-H potential values in solutions of different pH are collected this way to generate a pH potential plot.

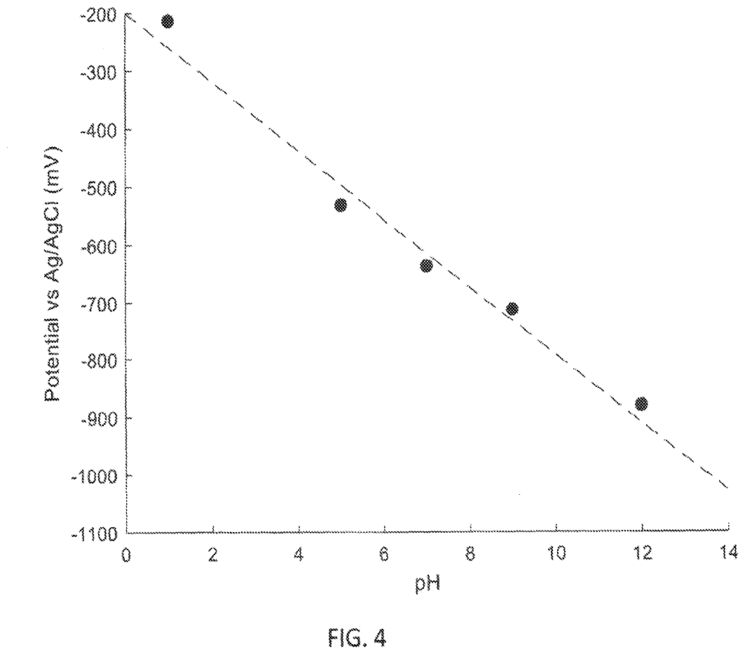

FIG. 4 shows potential of an exemplary hydrogen-loaded palladium electrode of the invention as a function of pH. The working electrode was a palladium wire (diameter=0.25 millimeters) with a surface area of 1 cm², the counter electrode was also palladium wire with a surface area of 3 cm², and the reference electrode was Ag/AgCl. The electrolyte was equilibrated with an inert gas (e.g. an argon atmosphere) above the solution. Prior to measurement of potential vs the reference electrode, the palladium electrode was loaded with hydrogen galvanostatically at 500 uA. The pH of an electrolyte solution was then adjusted by mixing a desired volume of dilute aqueous sulfuric acid solution (0.1 M) and a desired volume of dilute aqueous sodium hydroxide solution (0.1 M), and the pH of each mixed electrolyte solution was measured with a commercial glass electrode. The measured conductivity of the electrolyte solutions was 1 mS/cm.

Shown in FIG. 4 is a correlation regression line which serves as a calibration curve to correlate the potential of the Pd cathode and pH of the solution that contains the Pd cathode. Accordingly, the pH of a new solution can be obtained by measuring the potential of the Pd cathode versus SSE and using the calibration curve in FIG. 4 to find the pH in that new solution. The measured potential of the Pd cathode in the new solution is the y-value of the correlation regression line in FIG. 4, and the x-axis intercept is the pH of the new solution.

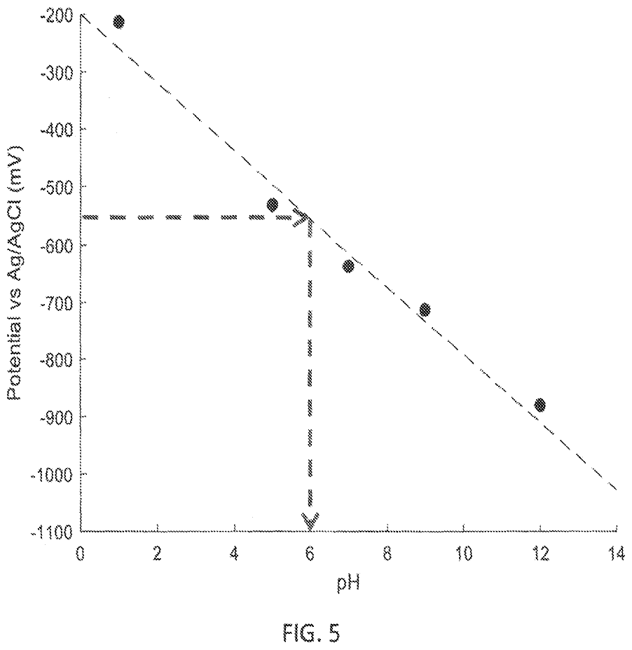

FIG. 5 is a graph illustrating use of the correlation regression line shown in FIG. 4 (dashed line) as a calibration curve to find the pH of a new solution. The potential of the Pd cathode in the new solution was measured to be −550 mv versus SSE. Referring to FIG. 4, when the y-measured value was-550 mV, the corresponding pH value of the calibration solution was 6, and thus the corresponding pH value of the new solution was reported as 6.

Without wishing to limit the invention to a particular theory, for palladium films of sufficient thickness (Pd thickness >˜500 nm), the hydrogen atoms remain in the Pd metal film long enough (e.g., a minute or longer) to permit these measurements of Pd potential versus SSE. Palladium films of approximately 500 nm retain enough hydrogen to make a pH sensitive measurement on the time scale of minutes. In some embodiments, the palladium wire (e.g., 0.25 mm diameter) retains enough hydrogen to make a pH sensitive measurement on the order of hours.

Without wishing to limit the invention to a particular theory, for thinner films (˜200 nm or less), hydrogen escapes the Pd metal film quickly (within seconds) which makes measurement of Pd potential versus SSE difficult. The thin films of Pd metal can optionally be covered with a membrane, for example a sulfonated polytetrafluoroethylene membrane (e.g., NAFION) to slow down the escape of hydrogen long enough (minutes) to permit measurement of Pd potential versus SSE. A suitable thickness of the membrane may be determined experimentally. In some embodiments, a membrane may have a thickness on the order of about 25 micrometers (or less).

In some embodiments, the invention encompasses a palladium reversible hydrogen electrode (RHE) article, wherein said article comprises palladium, wherein the palladium is palladium metal or a palladium alloy, and wherein the palladium is dynamically loaded with hydrogen atoms to reversibly form Pd-H species. In further embodiments, the palladium is palladium metal. Said palladium may be a palladium alloy. In some embodiments, the palladium limiralloy includes alloys of palladium with Ag, Cu, Mn, Ni, Cr, and combinations thereof.

In some embodiments of the RHE article, the palladium is in the form of a palladium film or a palladium wire. Suitable dimensions of the film and wire can be selected to enable pH reading using the RHE. In some embodiments, when the palladium is a palladium film. The film may have a thickness a range of from about 100 nm to about 2000 nm, in a range of from about 200 nm to about 2000 nm, in a range of from about 500 nm to about 1000 nm, or even about 500 nm. In some embodiments, when the palladium is in the form of a wire, the diameter of the wire is in a range of from about 0.1 mm to about 1 mm, from about 0.2 mm to about 0.5 mm, or about 0.25 mm.

In some embodiments, the RHE article of the invention comprising a palladium film, wherein said palladium retains atomic hydrogen for at least about 1 minute. In other embodiments, the RHE article of the invention comprises a palladium wire, wherein said palladium retains atomic hydrogen over a time ranging from at least a minute up to about 3 hours, or even longer. One advantage is that it allows multiple pH readings during this extended time range.

In some embodiments, the RHE article according the invention further comprises a membrane covering over the palladium. The membrane extend the retention time of hydrogen in the palladium. An example of a suitable membrane is a sulfonated polytetrafluoroethylene membrane (e.g., NAFION). However, the membrane is not required for making a pH measurement.

In some embodiments, the RHE article comprises less than 0.01% by weight of platinum with respect to the weight of the palladium. In further embodiments, the RHE article includes is free of platinum.

Another aspect according to the invention pertains to a pH measurement device, said device comprising a cathode and anode, and optionally, a pH insensitive silver/silver chloride reference electrode (SSE) which serves as the anode, and wherein said an RHE article according to the invention which serves as the cathode. In some embodiments, the pH measurement device further comprises a gold counter electrode serves as the anode. In some embodiments, the working electrode is a palladium, or a palladium alloy, wire. In further embodiments, the counter electrode is also a palladium, or a palladium alloy, film. In further embodiments, the reference electrode is an SSE.

In some embodiments, the pH measurement device comprises additional components and features, for example, a readout component, switches, voltameter, a power supply, a current meter, cover, and/or Bluetooth capability.

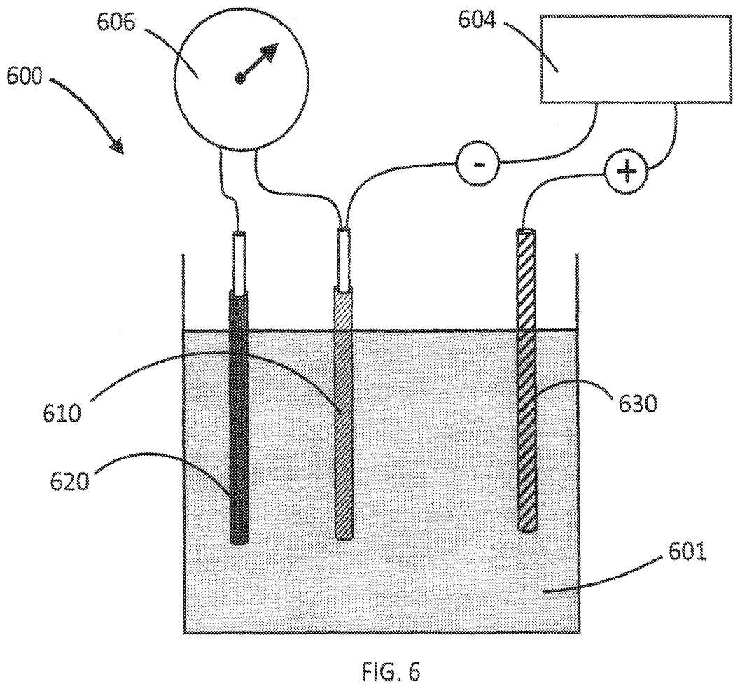

FIG. 6 is a schematic diagram of an exemplary embodiment of a pH measurement device 600 according to the invention, for measuring the pH of a solution 601. The pH measurement device 600 comprises several electrodes including a reversible hydrogen electrode 610 of the invention as a working electrode (cathode), as well as a reference electrode 620 and a counter electrode (anode) 630. In some embodiments, reference electrode 620 may be a silver/silver chloride electrode. In some embodiments, counter electrode 630 may be a gold electrode.

Electrodes 610, 620 and 630 are shown in FIG. 6 as spaced apart from each other in solution 601.

Also shown in FIG. 6 are a power supply/current meter 604 and a voltmeter 606 attached to electrodes 610, 620 and 630 in an exemplary configuration suitable for making pH measurements.

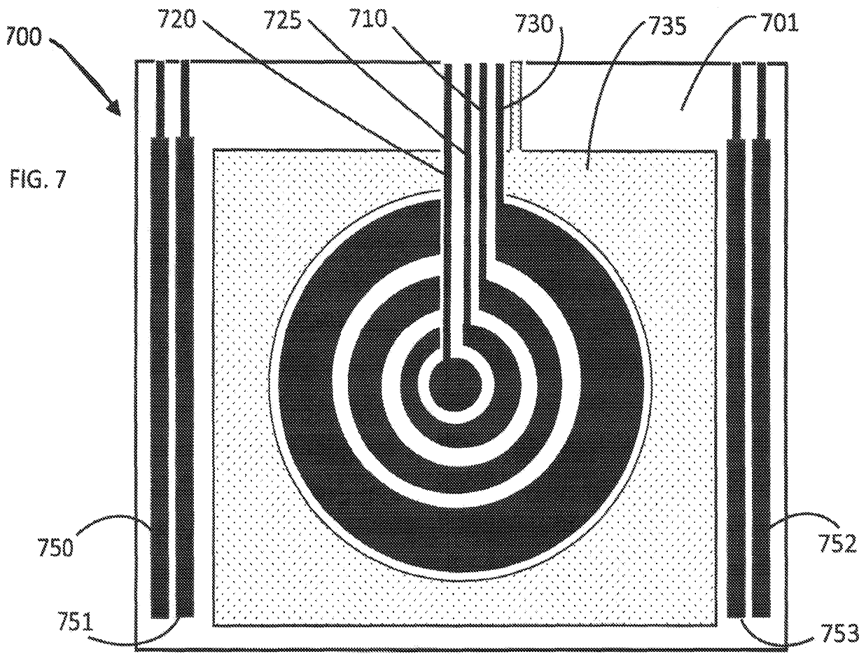

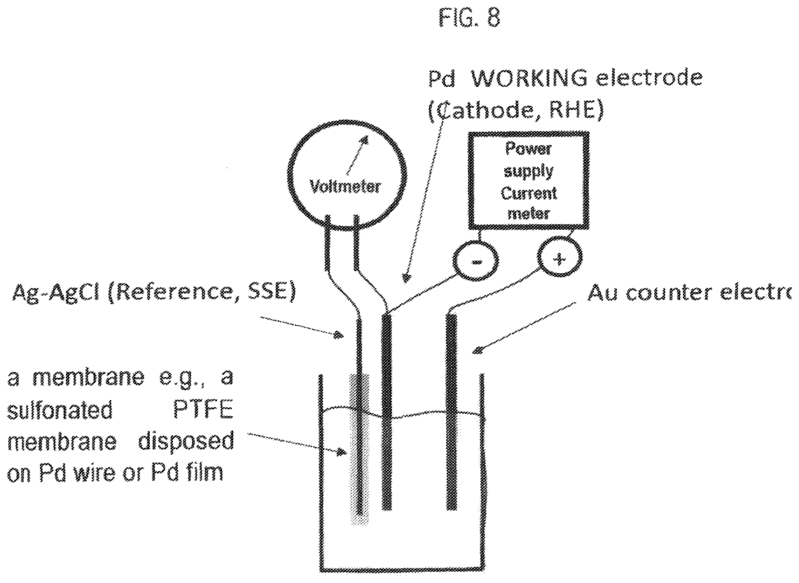

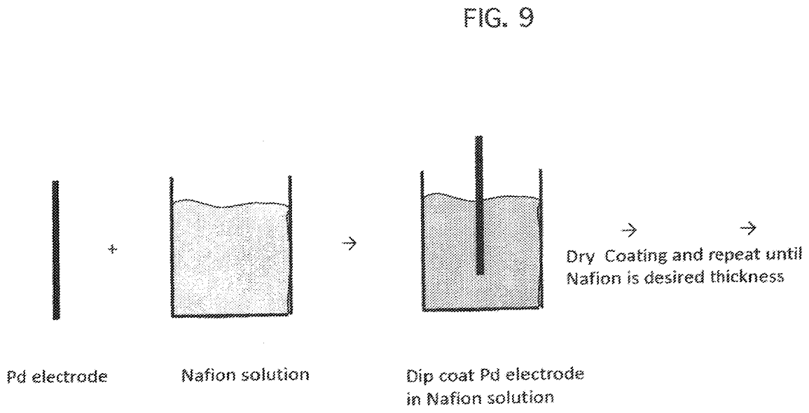

FIG. 7 is a schematic diagram of an exemplary embodiment of a pH measurement device 700 according to the invention, illustrating a layout of the pH measurement device 700 suitable for a chip or wafer format. The pH measurement device 700 comprises multiple electrodes disposed on a substrate 701 (“a multiple electrode configuration”). The multiple electrodes configuration comprises a palladium reversible hydrogen electrode 710 according to the invention, two silver electrodes 720 and 725 (reference electrodes), a working electrode 730 and a counter electrode 735. In some embodiments, material for working electrode 730 and counter electrode 735 may be, for example, gold or gold alloy.

In the exemplary embodiment shown in FIG. 7, electrodes 710, 720, 725, 730, 735 are palladium films arranged spaced apart on substrate 701, in a generally concentric layout. Each electrode is shown as having a narrow trace (e.g., about 1 mm) extending to an edge of substrate 701, which may be used, for example, for connection to an electrical connector. The electrodes may have a thickness of about 200 nm, although the thickness may be in a range of from about 100 nm to about 2000 nm, in a range of from about 200 nm to about 2000 nm, or even in a range of from about 200 nm to about 1000 nm.

Also shown on pH measurement device 700 are conductivity probes 750, 751, 752, and 753 disposed on substrate 701. A suitable material for conductivity probes 750-753 may, platinum (or platinum alloy). A suitable width for conductivity probes 750-753 may include, for example, about 1 mm. In some embodiments, the area of the working electrode (WE) is the same as the area of the counter electrode (for example, about 0.5 cm²).

FIG. 8. An exemplary method of measuring pH according to the invention. FIG. 8, also provides an exemplary configuration of the pH measurement device according to the invention.

FIG. 9. An exemplary method showing preparation of a membrane disposed on the wire or film (e.g., a sulfonated PTFE (NAFION) membrane disposed on Pd wire or Pd film).

In some embodiments according to the invention, the RHE article may be in a chip or wafer, or may be disposed on a chip or wafer. This conveniently allows for miniaturization. In embodiments of a chip including the RHE article, the palladium may typically be in the form of a film, although this is not a necessary limitation.

In some embodiments, the invention encompasses a chip or wafer comprising an RHE of the invention. The chip or wafer may have dimensions of about 1 cm by about 1 cm, although larger and smaller dimensions can be envisioned, depending on the needs of particular pH measurement applications.

Another aspect according to the invention pertains to a method for measuring pH, said method comprising contacting an aqueous solution comprising said sample/component for measurement (e.g . . . , Pb ions in water) with a pH measurement device according to the invention.

In some embodiments, the method comprising establishing a physical contact between the aqueous sample and the RHE according to the invention, the aqueous sample and the SSE; wherein the RHE and the SSE are spaced apart from each other in the aqueous sample;
allowing an equilibration time (e.g., about 1 min);
measuring an open circuit voltage (OCV) between the RHE and SSE; and
converting the OCV to a hydrogen ion concentration value, according to the following form of the Nernst equation:

$${E}^{RHE} = + 0.2 V - ( 0.0592 V ) log [ {H}^{+} ] . \qquad ( Equation V )$$

In some embodiments, the palladium in the RHE article is a palladium film. In some other embodiments of the method, the palladium in the RHE is a palladium wire. In some embodiments, the palladium in the RHE has a membrane coating. An example of a suitable membrane covering the palladium is a sulfonated polytetrafluoroethylene membrane (e.g., NAFION).

A further aspect of the invention pertains to a method is for making an RHE article said method comprising loading palladium of the RHE with hydrogen atoms (e.g., electrodynamically). In some embodiments, the palladium is in the form of a film. In some other embodiments, the palladium is in the form of a wire. In further embodiments, the method optionally includes covering the palladium with, for example, a membrane coating (e.g., a sulfonated polytetrafluoroethylene membrane), and then electrodynamically loading palladium with hydrogen atoms. However, that the membrane is not always required for making a pH measurement. In some embodiments, the electrodynamic loading step includes galvanostatic loading.

One aspect of the invention pertains to a reversible hydrogen electrode (RHE) article comprising:
palladium, wherein the palladium is palladium metal or a palladium alloy; and wherein the palladium is dynamically loaded with hydrogen atoms to reversibly form Pd-H species.

In some embodiments, the palladium is in the form of a palladium film or in the form of a palladium wire.

In some embodiments, a sulfonated polytetrafluoroethylene membrane coating is disposed on the palladium film or on the palladium wire.

In some embodiments, the palladium film has a thickness in a range of from about 100 nm to about 2000 nm, or in a range of from about 200 nm to about 2000 nm, or in a range of from about 200 nm to about 1000 nm, or even about 500 nm.

In some embodiments, the palladium retains atomic hydrogen for at least one minute.

In some embodiments, the palladium wire has a diameter in a range of from 0.1 mm to about 2 mm, from about 0.2 mm to about 0.5 mm, or even about 0.25 mm.

In some embodiments, the palladium wire retains atomic hydrogen for at least about 1 minute up to about 3 hours.

In some embodiments, the reversible hydrogen electrode comprises less than 0.01% by weight of platinum, or no platinum.

In some embodiments, the palladium of the reversible hydrogen electrode is palladium metal.

In some embodiments, the palladium of the reversible hydrogen electrode the palladium is an alloy of palladium with a metal chosen from Ag, Cu, Mn, Ni, Cr, or combinations thereof.

In some embodiments, the reversible hydrogen electrode is disposed on a substrate comprising a plastic, glass, alumina, or silicon.

In some embodiments, the reversible hydrogen electrode is disposed on a fused silica substrate.

In some embodiments, the reversible hydrogen electrode is disposed on a non-doped silicon substrate.

Another aspect of the invention pertains to a pH measurement device comprising a cathode and an anode; wherein a reversible hydrogen electrode (RHE) article according to the invention serves as the cathode; and wherein a pH insensitive silver/silver chloride reference electrode (SSE) serves as the anode.

In some embodiments of the pH measurement device of the invention, the reversible hydrogen electrode is disposed on a substrate comprising a plastic, glass, alumina, or silicon.

In some embodiments of the pH measurement device of the invention, the reversible hydrogen electrode is disposed on a fused silica substrate.

In some embodiments of the pH measurement device of the invention, the reversible hydrogen electrode is disposed on a non-doped silicon substrate.

In some embodiments, the pH measurement device of the invention comprises a gold counter electrode.

In some embodiments, the pH measurement device of the invention comprises at least one platinum conductivity probe.

In some embodiments, the pH measurement device of the invention is a square chip having edge dimensions of about 1 cm by 1 cm.

In another aspect of the invention, a method of measuring pH comprises
a) with a pH measurement device according to the invention, establishing a physical contact between an aqueous sample and the reversible hydrogen electrode (RHE), the aqueous sample and the silver/silver chloride reference electrode (SSE); wherein the RHE and the SSE are spaced apart from each other in the aqueous sample;
b) allowing an equilibration time; and
c) measuring an open circuit voltage (OCV) between the RHE and SSE; and
converting the OCV to a hydrogen ion concentration value, according to the following form of the Nernst equation:

$${E}^{RHE} = + 0.2 V - ( 0.0592 V ) log [ {H}^{+} ] . \qquad ( Equation V )$$

In some embodiments of measuring pH with a pH device of the invention, the equilibration time is about 1 minute.

In some embodiments of measuring pH with a pH device of the invention, the palladium in the RHE is a palladium film.

In some embodiments of measuring pH with a pH device of the invention, the palladium in the RHE is a palladium wire.

In some embodiments of measuring pH with a pH device of the invention, the palladium is coated with a membrane coating comprises a sulfonated polytetrafluoroethylene.

In another aspect of the invention, a method of making a reversible hydrogen electrode (RHE) article of the invention comprises electrodynamically loading palladium with hydrogen atoms; wherein the palladium is one of a palladium film and a palladium wire.

In some embodiments of making a reversible hydrogen electrode of the invention, the electrodynamically loading step comprises galvanostatic loading.

In some embodiments of making a reversible hydrogen electrode of the invention comprises coating the palladium wire or palladium film with a membrane coating.

In some embodiments of making a reversible hydrogen electrode of the invention comprising coating the palladium wire or palladium film with a membrane coating, the membrane coating comprises a sulfonated polytetrafluoroethylene.

All publications mentioned herein are incorporated by reference to the extent they support the present invention.

We claim:

1. A reversible hydrogen electrode (RHE) article comprising:
palladium, wherein the palladium is palladium metal or a palladium alloy; and wherein the palladium is dynamically loaded with hydrogen atoms to reversibly form Pd-H species.

2. The article of claim 1, wherein the palladium is in the form of a palladium film or in the form of a palladium wire.

3. The article of claim 2, further comprising a sulfonated polytetrafluoroethylene membrane coating disposed on the palladium film or on the palladium wire.

4. The article of claim 2, wherein the palladium film has a thickness in a range of from about 100 nm to about 2000 nm.

5. The article of any of the preceding claims, wherein the palladium retains atomic hydrogen for at least one minute.

6. The article of claim 2, wherein the palladium wire has a diameter in a range of from about 0.2 mm to about 2 mm in diameter.

7. The article of claim 2, wherein the palladium wire retains atomic hydrogen for at least about 1 minute up to about 3 hours.

8. The article of any one of claims 1 to 7, wherein said article comprising less than 0.01% by weight of platinum, or no platinum.

9. The article of any one of claims 1 to 8, wherein the palladium is palladium metal.

10. The article of any one of claims 1 to 8, wherein the palladium is an alloy of palladium with a metal chosen from Ag, Cu, Mn, Ni, Cr, or combinations thereof.

11. The article of any one of claims 1 to 10, wherein the reversible hydrogen electrode is disposed on a substrate comprising a plastic, glass, alumina, or silicon.

12. A pH measurement device comprising a cathode and an anode;
wherein a reversible hydrogen electrode (RHE) article according to any one of claims 1 to 9 serves is the cathode; and
wherein a pH insensitive silver/silver chloride reference electrode (SSE) is the anode.

13. The pH measurement device of claim 12, wherein the reversible hydrogen electrode is disposed on a substrate comprising a plastic, glass, alumina, or silicon.

14. The pH measurement device of any one of claims 12 to 13, further comprising a gold counter electrode.

15. The pH measurement device of any one of claims 12 to 14, further comprising at least one platinum conductivity probe.

16. The pH measurement device of any one of claims 12 to 15, wherein the pH measurement device is a square chip having edge dimensions of about 1 cm by 1 cm.

17. A method of measuring pH, said method comprising:
a) with a pH measurement device according to any one of claims 12-16, establishing a physical contact between an aqueous sample and the RHE, the aqueous sample and the SSE; and wherein the RHE and the SSE are spaced apart from each other in the aqueous sample;
b) allowing an equilibration time; and
c) measuring an open circuit voltage (OCV) between the RHE and SSE; and
converting the OCV to a hydrogen ion concentration value, according to the following form of the Nernst equation:
$${E}^{RHE} = + 0.2 V - ( 0.0592 V ) log [ {H}^{+} ] . \qquad ( Equation V )$$

18. The method according to claim 17, wherein the equilibration time is about 1 minute.

19. The method according to any one of claims 17 to 18, wherein the palladium in the RHE is a palladium film.

20. The method according to any one of claims 17 to 19, wherein the palladium in the RHE is a palladium wire.

21. The method according to any one of claims 17 to 20, wherein the palladium is coated with a membrane coating comprising a sulfonated polytetrafluoroethylene.

22. A method of making a reversible hydrogen electrode (RHE) article of any one of claims 1 to 11, said method comprising:
electrodynamically loading palladium with hydrogen atoms;
wherein the palladium is one of a palladium film and a palladium wire.

23. The method according to claim 22, wherein the electrodynamically loading step comprises galvanostatic loading.

24. The method according to any one of claims 22 to 23, further comprising coating the palladium wire or palladium film with a membrane coating.

25. The method of claim 24, wherein the membrane coating comprises a sulfonated polytetrafluoroethylene.

26. A method of detecting ions in water (e.g. lead ions in water), said method comprising contacting an RHE according to claim 1 with an aqueous solution containing ions (such as lead ions).

27. A miniaturized electrochemical sensor device, said device comprising a cathode and an anode;
wherein a reversible hydrogen electrode (RHE) article according to any one of claims 1 to 9 serves as the cathode; and
wherein a pH insensitive silver/silver chloride reference electrode (SSE) is the anode, and optionally wherein a gold or gold alloy counter electrode is an anode;
wherein said RHE is within, or disposed on, a chip or wafer (e.g. glass or silicon, such as undoped silicon).

28. The miniaturized electrochemical sensor device, said device further comprising a connector.
